(19) United States
(12) Patent Application Publication
(10) Pub. No.: US 2019/0338830 A1
(43) Pub. Date: Nov. 7, 2019

(54) SINGLE PIECE QUICK CONNECT AND DISCONNECT CHASSIS SYSTEMS

(71) Applicant: Charles Dwight Jarvis, Jonesboro, GA (US)

(72) Inventor: Charles Dwight Jarvis, Jonesboro, GA (US)

(73) Assignee: INNOTECH ASSOCIATES-PMT5, LLC, Jonesboro, GA (US)

(21) Appl. No.: 15/973,436

(22) Filed: May 7, 2018

(51) Int. Cl. F16G 11/10

(52) U.S. Cl. CPC F16G 11/10; B60D 1/187

(57) ABSTRACT

Implementations of a single piece, quick connect and disconnect (SP-QCD chassis) system for connecting and disconnecting a load via a rope to a pulling force that includes a load bar connected to a first rail and a second rail, a locking bar connected to the load bar by a third rail and a connection point for attaching various state-of-the-art connecting devices of pulling forces. The rope, the load bar, and the locking bar are used to form a QCD knot that may be tied and untied relatively quickly. One end of a SP-QCD system can be attached to a pulling force and one leg of the knot formed on the SP-QCD may be connected to a load. In this way, a load can be connected to and disconnected from a pulling force relatively quickly.

### CROSS REFERENCE TO RELATED APPLICATION

The present non-provisional patent application references U.S. Pat. No. 8,608,211 “Quick Connect/Disconnect Rope Hitch” issued Dec. 17, 2013, portions of which may be paraphrased or repeated herein to better present this disclosure and is incorporated herein by reference in its entirety.

### TECHNICAL FIELD

This disclosure relates to a single-piece chassis on which a quick connect and disconnect knot may be tied using a rope, strap or other similar binding medium.

### BACKGROUND

An object may be transported or secured by connecting a chain, cable, strap, or rope to the object.

However, there are disadvantages to connecting and transporting an object with a chain, cable, or strap. Chains are relatively expensive and heavy. Furthermore, the connection formed using a chain can be dangerous when lever load binders are used. If the tension on a chain is lessened and a grab hook is being used to connect it, then the grab hook may come loose, making the connection unreliable. Still further due to its weight, the practical length of a chain limits its use for applying force to an object that is approximately 30 feet or more from the pulling force. An example for which a chain is poorly suited is attaching a rope to the top of a tree to guide its direction of fall when cutting it down.

Although wire cables can be less expensive and less heavy than chains, cables are relatively stiff and may have frayed wires, thereby making cables difficult to handle by hand. Cables, like chains, do not have the practical reach that ropes have.

Straps are generally used with a ratcheting system. However, operating a ratchet may be a relatively complicated, time consuming, and a high-strength process (when releasing the ratcheting mechanism to remove the strap).

A rope may be the most cost-effective instrument for transporting or securing an object when there is no abrasion on the rope. The minimum breaking force for modern ropes are increasing dramatically with a ⅜″ diameter rope, typically, having a minimum breaking strength of 5,500 pounds, a ⅝″ diameter rope having a minimum breaking strength of 8,500 pounds and a 1½″ diameter rope having a strength of 35,000 pounds. Ropes do not pose the problem of scratching or chipping delicate items such as a grand piano or a polished granite block that a chain may have. Modern ropes are exceptionally strong and still available at lengths up to 1000 feet and longer. However, existing rope tying techniques can be complex and time consuming to both tie and untie. The more pressure applied to a rope knot, the more difficult it may be to untie. Also, knots may reduce the minimum breaking strength of a rope, sometimes up to 40%.

Historically, chains with load binders and straps with ratchet mechanisms have one major advantage over ropes in that a connection can be made easily at any point along the length of the chain or strap. The QCD knot of U.S. Pat. No. 8,608,211 corrected this situation, but the multiple component QCD chassis was expensive to build and not as fast as the present disclosure.

The above problems with chains, cables, straps, and ropes may be magnified for people with physical impairments, limited strength and grip, and/or limited experience.

### BRIEF DESCRIPTION OF THE DRAWINGS

FIGS. 1A and 1B illustrate an example implementation of a quick connect and disconnect (QCD) system according to the principles of U.S. Pat. No. 8,608,211.

FIGS. 2A and 2B illustrate an example implementation of a single piece quick connect/disconnect (SP-QCD) chassis according to this disclosure.

FIG. 3A through 3F illustrate an example method for tying a quick connect and disconnect knot to a SP-QCD chassis according to the principles of this disclosure.

FIGS. 4A through 4F illustrate an example method for tying a quick connect and disconnect knot in a QCD system according to the principles of U.S. Pat. No. 8,608,211.

FIGS. 5A through 5D illustrate an example method for untying a QCD quick connect and disconnect knot from a SP-QCD chassis according to the principles of this disclosure.

FIGS. 6A through 6F illustrate example SP-QCD chassis configurations for different state-of-the-art hitching systems.

FIGS. 7A and 7B illustrate an example utilization of a SP-QCD chassis according to the principles of this disclosure.

### DETAILED DESCRIPTION

Various implementations of this disclosure provide lower cost apparatuses and methods for quickly and reliably connecting and disconnecting a rope or strap that may be attached to a load on one end and to a pulling force on the other end. In the detailed description of this disclosure, implementations are illustrated using a rope. But a strap or other binding medium may be substituted for the rope in all example illustrations. As with the QCD, implementations of a single-piece quick connect and disconnect (SP-QCD) chassis may include a load bar connected to a first rail and a second rail, that are in turn connected to a pulling force, and a locking bar (which is equivalent in function to the QCD compression pin assembly) that is connected to the load bar by a third rail. The first and second rails may be fashioned in a variety of configurations to accommodate different hitching systems to a pulling force. A rope or strap, the load bar, and the locking bar are used to form locking and compression knots that may be tied and untied relatively quickly. As with the QCD, one end of a SP-QCD system can be attached to a pulling force and one leg of the knot formed on the SP-QCD may be connected to a load. In this way, a load can be connected to and disconnected from a pulling force relatively quickly after releasing tension.

The primary difference between a QCD chassis and a SP-QCD chassis is that with the QCD, the locking bar is inserted between loops of rope to lock the compression knots while the loops of rope are placed around a fixed locking bar in the case of the SP-QCD to lock equivalent compression knots. Applicable figures of U.S. Pat. No. 8,608,211 are reproduced in this disclosure's illustrations to emphasize and illustrate this point.

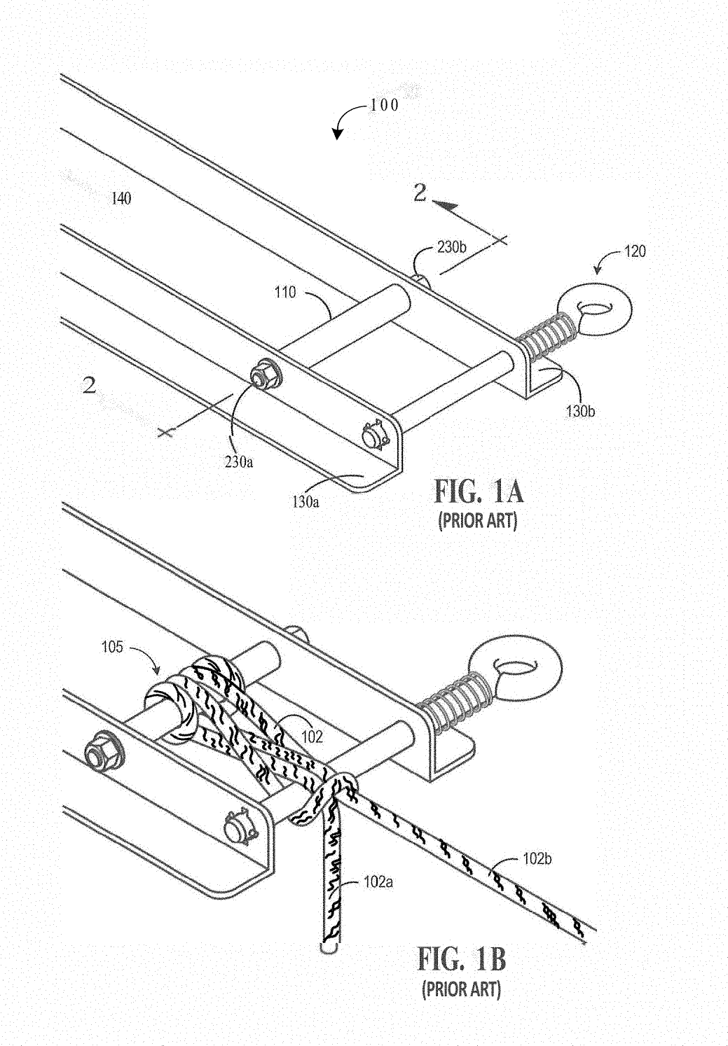

For example, FIGS. 1A and 1B illustrate an example implementation of a multi-piece quick connect and disconnect (QCD) rope system 100 per the principles of U.S. Pat. No. 8,608,211 for connecting and disconnecting a load via a rope 102 to a pulling force (not shown) such as a motor vehicle on the pulling force end 140 of the QCD system. The QCD system 100 comprises a load bar 110, a compression pin assembly 120, a left rail 130a, a right rail 130b, and QCD knot 105. The load bar 110 is connected between the left rail 130a and the right rail 130b and the compression pin assembly 120 is configured to be inserted between the left rail 130a and the right rail 130b.

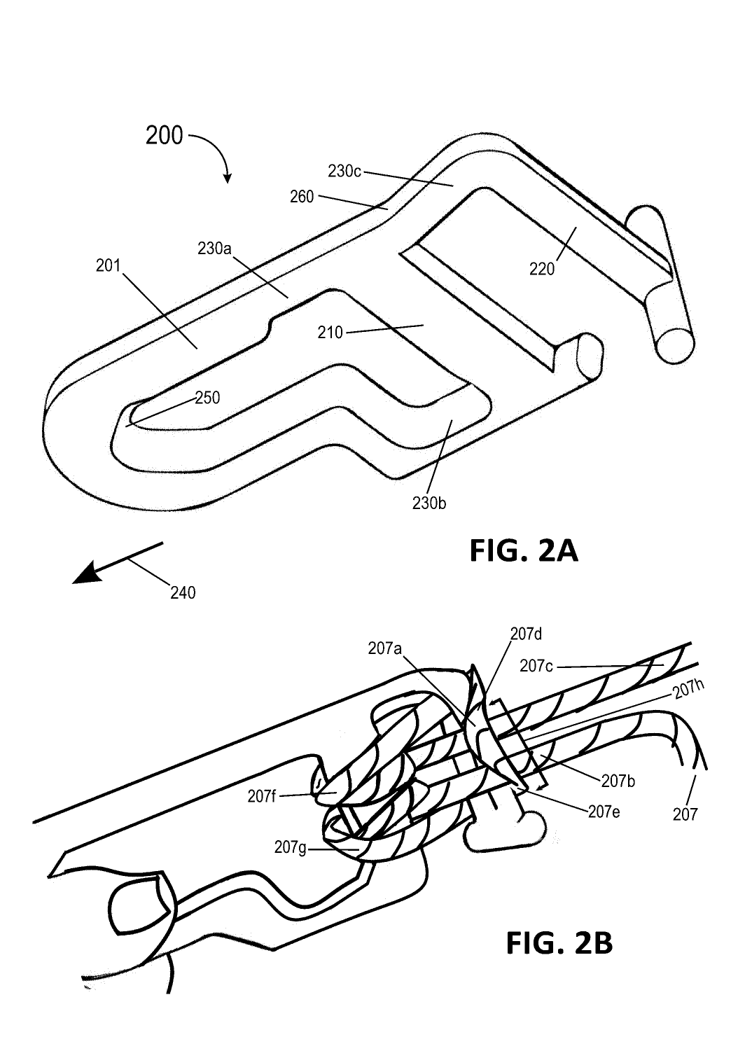

FIGS. 2A and 2B illustrate an example implementation 200 of a single-piece quick connect and disconnect (SP-QCD) chassis 201 according to the principles of this disclosure for connecting and disconnecting a load via rope 207 to a pulling force (such as a load binder—not shown) that may apply a pulling force 240 on the end of the SP-QCD chassis 201 at point 250. The SP-QCD chassis 201 comprises a load bar 210, a conveniently located locking bar 220 that serves the function of the compression pin assembly 120 in FIG. 1B, a left rail 230a, a right rail 230b, a third rail 230c that is bent downward at point 260 to connect the locking bar 220 to the load bar 210, and a connection point 250 for attaching the pulling force connection. In some implementations such as securing a load on a flatbed truck, the pulling force is provided by a grabbing hook on a load binder. The load bar 210 is connected between the left rail 230a and the right rail 230b. The locking bar 220 is configured to be in position for the rope 207 to be looped around it, as is accomplished by insertion of the compression pin assembly 120 in FIG. 1B. As a result, the QCD knot/SP-QCD chassis system 200 may contain two compression points 207f and 207g, as well as a locking knot 207h (see rope 207 section 207d to 207e). The edges of the load bar 210 and locking bar 220, as well as all edges of SPQCD chassis 201 may be abraded and polished so that little or no abrasion or cutting of the rope by the edges of SP-QCD chassis 201 may occur.

As illustrated in FIG. 2B, bending 260 of the locking bar 220 downwards and pulling the load rope 207c taught (straight) may create an upward pull on the locking knot 207h by the load rope 207c and may keep the locking knot 207h from becoming tight around the locking bar which may facilitate untying the QCD knot after tension is released.

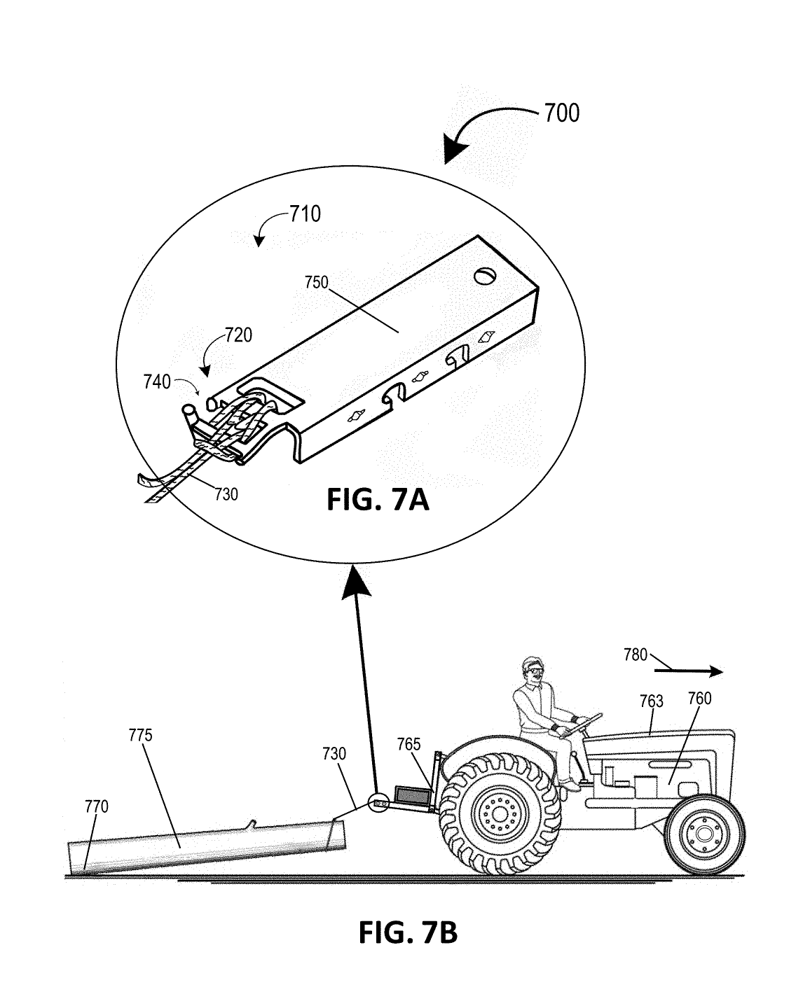

As an overall summary, FIGS. 7A and 7B illustrate an example SP-QCD/QCD knot implementation 700 in which a SP-QCD chassis 720 according to this disclosure may be used to pull a load. As shown in FIG. 7A, a SP-QCD/QCD knot assembly 710, according to the principles of the present disclosure, may utilize integral SP-QCD chassis 720 in adaptor 750 and QCD knot 740 to connect and disconnect rope 730. As shown in FIG. 7B, adaptor 750 may in turn be pulled along by the pulling-force-generating motor 760 on tractor 763 due to being attached to the three-point-hitch implement 765. The rope in turn is attached to a load 770 so that the log 775 may be “snaked” to the loading area 780 (not shown). As illustrated in FIGS. 7A and 7B, the SP-QCD chassis and QCD knot may form an essential role in a transportation system.

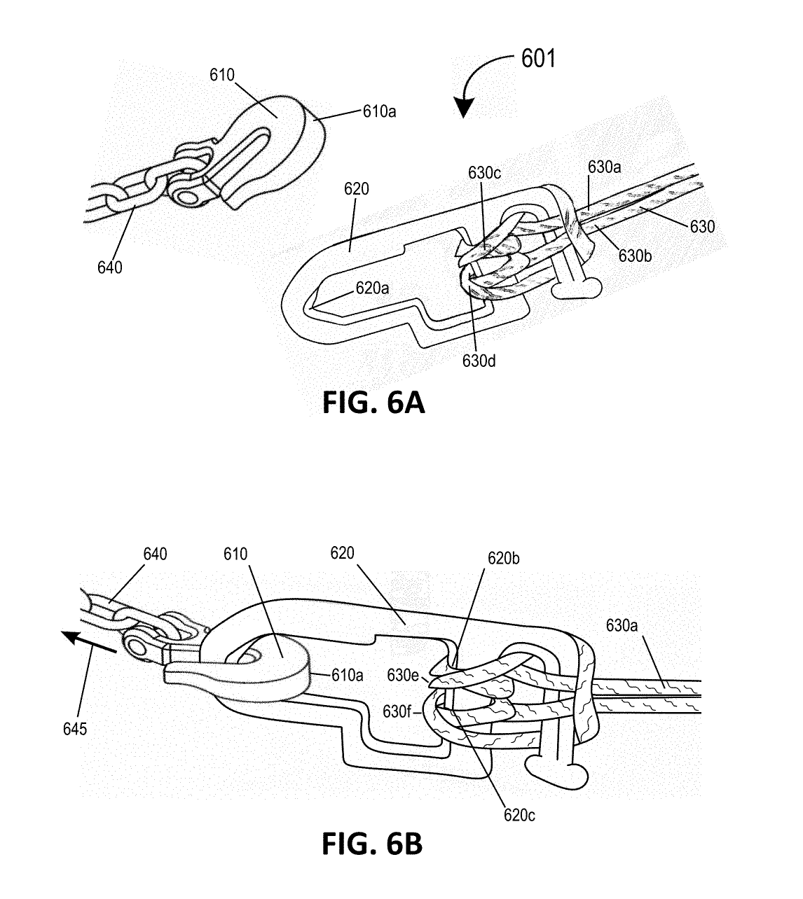

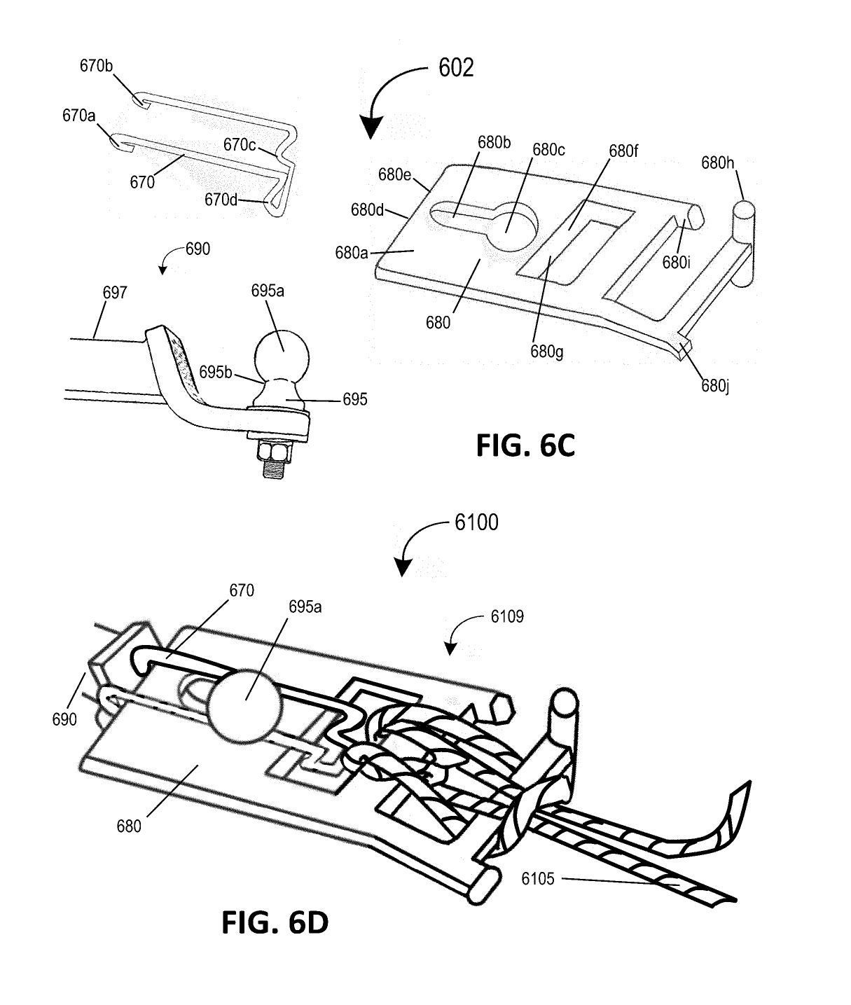

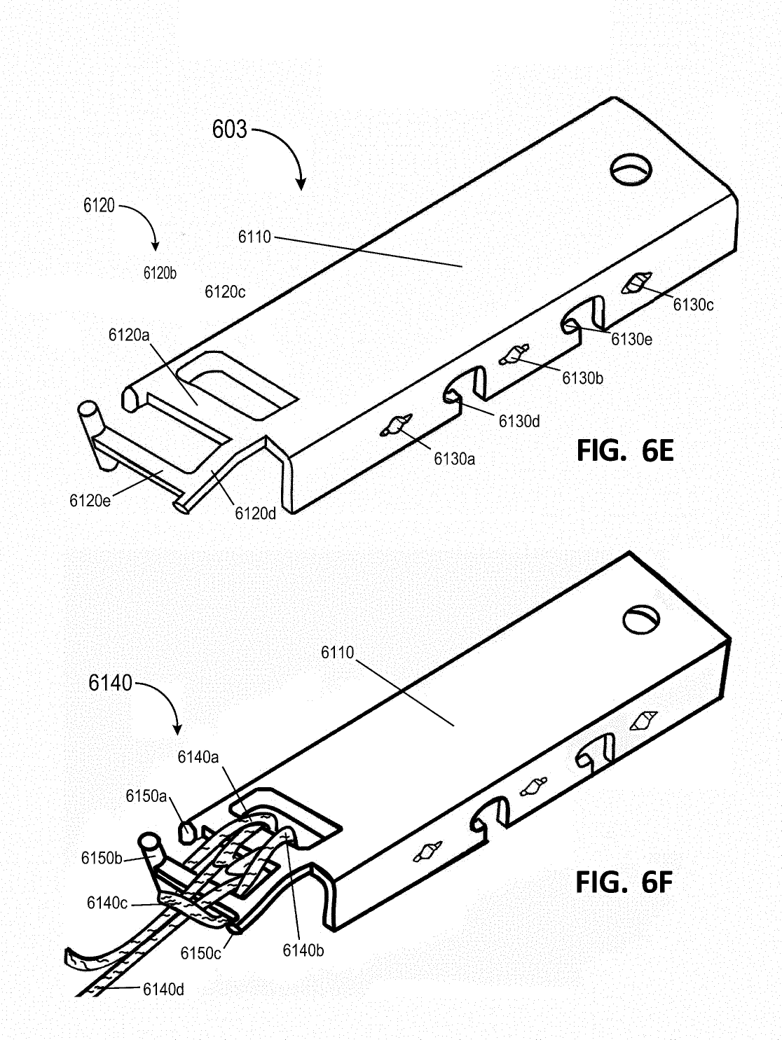

As will become evident, the principles of the present disclosure apply to a variety of SP-QCD chassis systems that include a load bar connected to a left rail and a right rail with a locking bar in a convenient position connected to the load bar by a third rail and to a variety of connection methodologies and configurations to accommodate different state-of-the-art hitching systems of different pulling forces. For example, FIG. 6A through FIG. 6F illustrate a few but not all example SP-QCD chassis configuration implementations with different rail configurations for different hitching systems.

FIGS. 6A and 6B illustrate a SP-QCD/QCD system 601 configured for a grabbing hook 610 that may be attached to SP-QCD chassis 620 and that may be present on chain 640 or a load binder (not shown). Load rope 630a may be attached to the load being either held in place or moved by the SP-QCD/QCD system 601.

The length dimension of SP-QCD chassis 620 may be specified so that there is minimum space between rope 630 compression knots 630c and 630d and the grab hook 610's end 610a. While providing enough room to easily insert, with a little force, grabbing hook 610, reducing this space may lower the probability that unwanted disconnects may occur when tension is slack in chain 640 during towing. FIG. 6B illustrates grabbing hook 610 in the pulling position. Grabbing hook 610 may be moved backwards toward compression knots 630c and 630d to unhook and then hook again. By specifying the length dimension of SP-QCD chassis 620, the end 610a of grabbing hook 610 may be in contact with ends 630e and 630f of compression knots 630c and 630d on insertion and may require a little force to hook and unhook. When chain 640 becomes slack, it may exert little to no pushing force on grabbing hook 610 due to the weight of the chain. The momentum of grabbing hook 610 may be insufficient to overcome the force required to force grabbing hook end 610a pass compression knots 630c and 630d, and a more reliable connection may be obtained. In some implementations, an analogous method may be utilized to hold a SP-QCD chassis on a ball hitch connection.

The overall shape of SP-QCD chassis 620 may also be controlled so that pulling contact point 620a is offset and may be in a straight line with load rope 630a. Groves 620b and 620c (location only shown with location beneath rope legs 630a and 630b) may be positioned so that rope legs 630a and 630b are in the proper position so that the compression knots 630c and 630d may be produced. Grove 620b, by being in a direct line with contact point 620a, may increase the probability that load rope 630a is in a straight line with chain 640 during the towing operation.

Instead of grabbing hook 610, many SP-QCD/QCD system implementations may use various types of shackles in implementations like SP-QCD/QCD system 601. Many other implementations may use various strength bungee cords with hooks on each end.

FIGS. 6C and 6D illustrate SP-QCD/QCD system implementation 602 configured for a standard ball and socket trailer hitch system 690 in which square bar 697 is inserted into a standard square tube (not shown) of a towing vehicle. As illustrated in FIG. 6D, placing hole 680c of SP-QCD chassis 680 around ball 695a of ball hitch knob 695 of hitch assembly 690 and pulling on SP-QCD chassis 680 so that neck 695b of ball knob 695 slides back into slot 680b may permit spring clip 670 to be inserted around neck 695b of ball hitch knob 695 and then to be clipped around the pulling end 680a of SP-QCD chassis 680. Hooks 670a & b and spring clips 670c & d may either hook around or apply pressure to points 680d, e, f & g, respectively, of SP-QCD 680. The clip 670 may prevent the SP-QCD chassis 680 from coming off ball knob 695 when breaks are applied on the pulling force and rope 6105 may become slack. SP-QCD chassis 680 may be attached to ball hitch 690 that in turn may be attached to a towing vehicle (not shown) via hitch assembly 690. In this case, assembly 6100 of FIG. 6D illustrates the towing of an object (not shown) that may be secured to rope 6105 that in turn may be secured to SP-QCD chassis 680 by QCD knot 6109.

FIG. 6E illustrates a SP-QCD system 603 where a SP-QCD chassis 6120 may be milled into adapter 6110 that may be attached to a three-point-hitch implement for tractors. SP-QCD chassis 6120 may be implemented by milling a load bar 6120a, a conveniently located locking bar 6120e, a left rail 6120b, a right rail 6120c, and a third rail 6120d that may connect the locking bar 6120e to the load bar 6120a in adapter 6110. Either of holes 6130a, 6130b and 6130c may be used to lock adapter 6110 in place. Contact points 6130d and 6130e may transmit the pulling force of the tractor to adapter 6110. As illustrated in FIG. 6F, adapter 6110 in turn may transmit the pulling force to rope load leg 6140d that may be tied to adapter 6110 by QCD knot 6140.

As shown in FIG. 6F, QCD knot 6140 may contain compression knots 6140a and 6140b and may also contain a locking knot 6140c. By holding legs 6140d and 6140e in place during the tying operation, protrusions 6150a, b & c, that may be milled in the SP-QCD chassis 6120, may facilitate tying of QCD knot 6140. In some implementations, protrusion 6150b may be milled parallel to locking bar 6120e instead of welded perpendicularly as in FIGS. 6E & F. As shown in FIGS. 6E and 6F, the towing methodology of this implementation using SP-QCD chassis 6120 may be configured according to the principles of this disclosure.

The SP-QCD chassis and QCD knot of this disclosure may be implemented and utilized in many other hitching methodologies. These include but are not limited to the standard tow-bar/u-tongue connection system that is commonly used for towing off-road trailers, to a hole in the pulling end that enables the floating hitching system that was disclosed by U.S. Pat. No. 8,360,460, “Floating Hitching System”, issued Jan. 29, 2013, to be utilized or for the SP-QCD to be bolted to the frame of a motor vehicle, and to the hook to rail or cleat connection system to bind loads that may be found in beds of pickups or flat-bed trucks and on marine docks to bind boats.

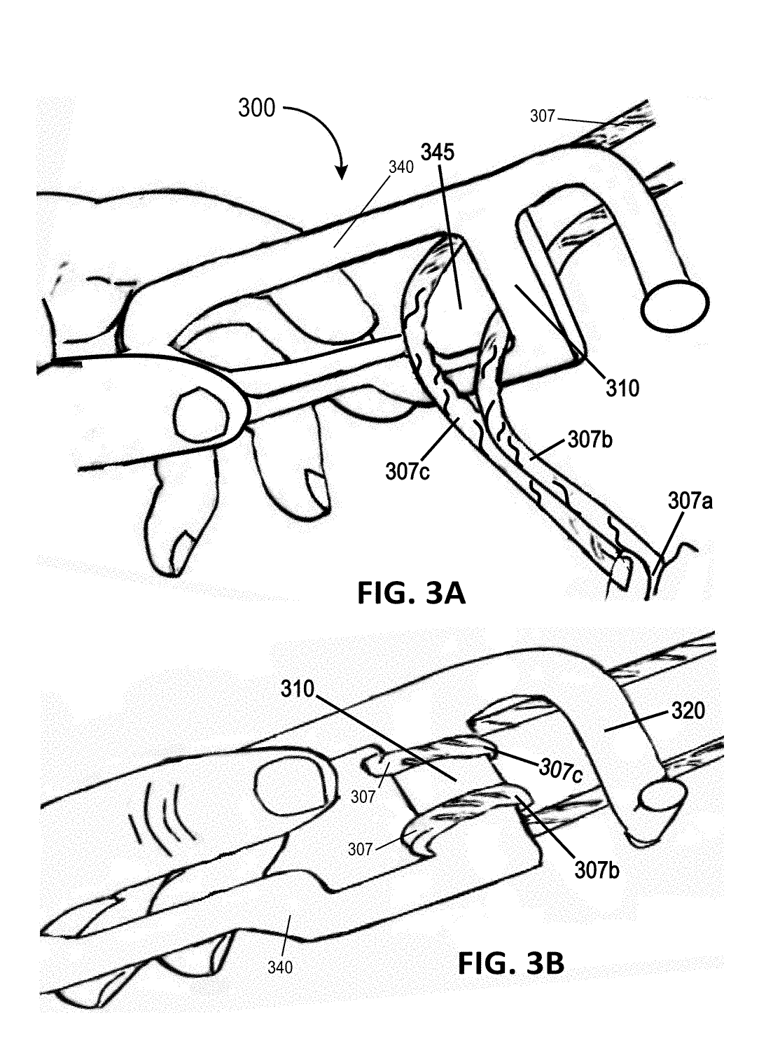

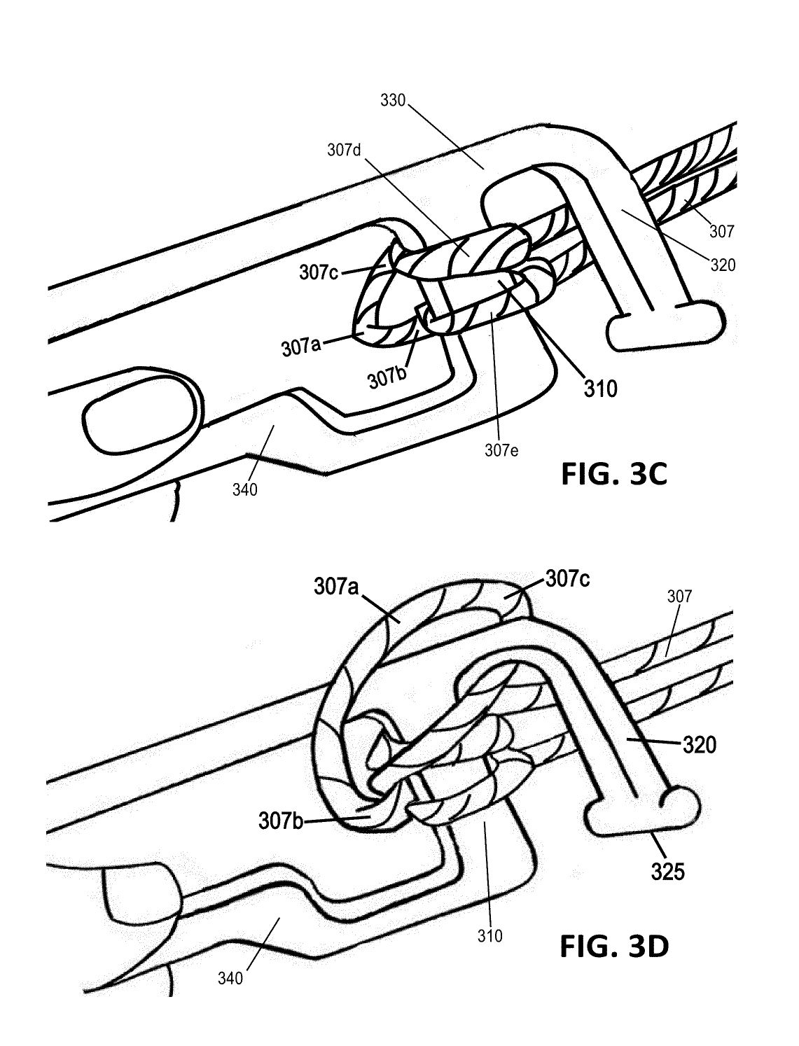

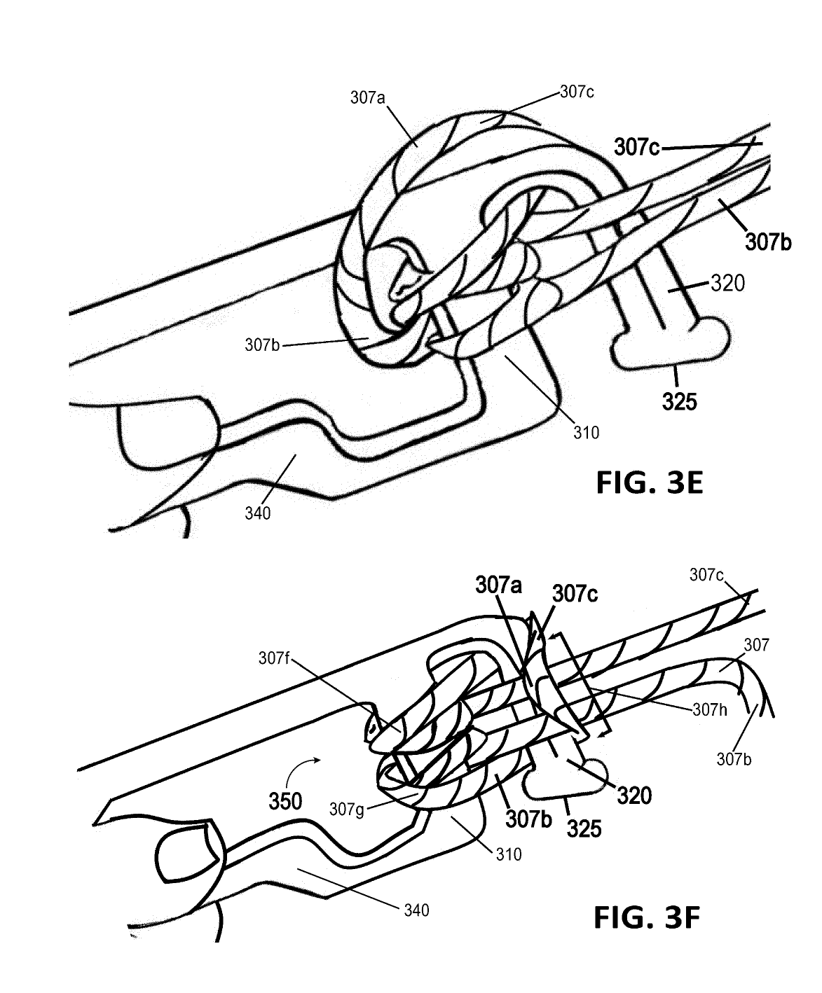

Returning to FIG. 3A, to tie a quick QCD knot in a SP-QCD/QCD system 300 to a SP-QCD chassis 340, first create a loop end 307a at any point along rope 307 to produce a load leg 307c and a loose-end leg 307b. Then, bring the loop end 307a under, up, and over the load bar 310 through hole 345 as shown in FIG. 3A.

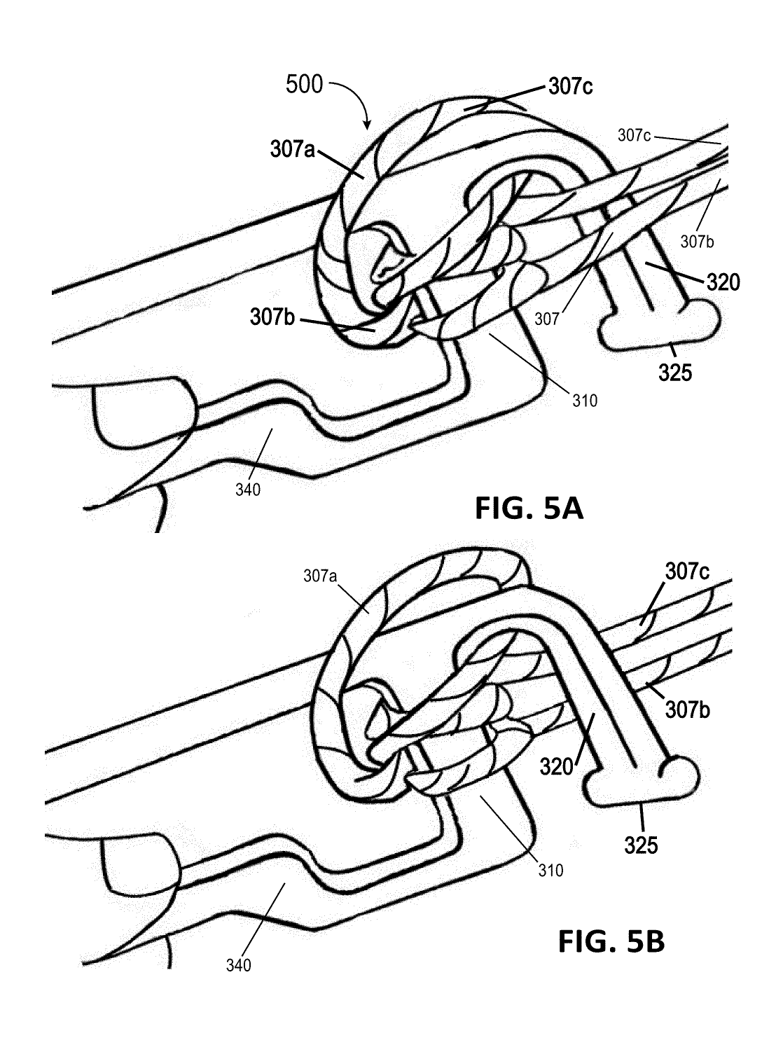

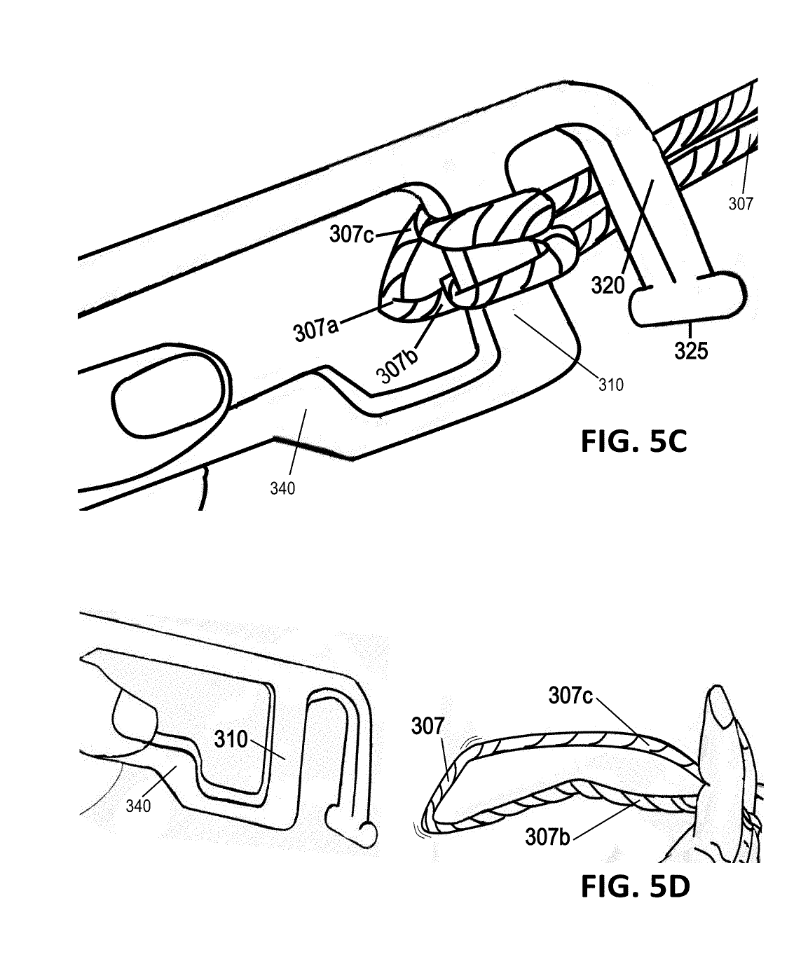

(In FIGS. 3A to 3F and 5A to 5D, it may be difficult to follow the movement of rope 307. For this reason, slightly larger fonts and wider lines of applicable numerals and indicating lines are utilized to indicate portions of the SP-QCD chassis 34 and rope 307 that are involved in the operation. Also, it is difficult to tell in some figures that there is only one rope 307 or where the load leg and free leg are located. For these reasons, duplicate indicating numbers are sometimes used in the same figure.)

Next, as illustrated in FIG. 3B, insert the loop end 307a (not shown) down between the load bar 310 and locking bar 320, and then further down between the rope legs 307b and 307c. As illustrated in FIG. 3C, bring the loop end 307a under, up, and over the load bar 310 again. By spreading the loop in this operation, compression points 260a and 260b of FIG. 2B may be produced. Compression knots may be formed at these points when tension is applied to load leg 307c of rope 307. Most of the load may occur at point 307d and the rest at point 307e for most towing implementations. The simple compression knots may reduce the debilitating impact of knots on the minimum breaking strength of ropes as compared to most other knots.

Then bring the load leg 307c of rope 307 around locking bar end 325 and under locking bar 320 as shown in FIG. 3D.

Then raise legs 307c and 307b up, around and over locking bar end 325 to rest on locking bar 320, as is illustrated in FIG. 3E.

Next, as illustrated in FIG. 3F, bring the loose-end leg 307b of loop end 307a up and over the rope legs 307c and 307b and then over and under the end 325 of locking bar 320. This operation locks the compression knots 307f and 307g in place. As more tension is placed on load leg 307c, more tension may then be placed on the rope-cross-over points or compression knots 307f and 307g.

Again, as illustrated in FIG. 3F, the knot may be tightened further when a pulling force (not shown) is applied to leg 307c which applies even more force on cross over points 307f and 307g. As a result, very little tension is passed along the rope to where it is positioned on locking bar 320. In addition, the load on leg 307c and the downward bend 330 in SP-QCD 340, illustrated in FIG. 3C, may pull load leg 307c up and above locking bar 320. This in turn may pull locking knot 307h upwards and tighter, i.e. farther up from the locking bar. This may reduce the probability of the rope locking mechanism knot 307h coming undone during a towing operation. Also, it may ensure that the locking portion 307h of rope 307 will be loose enough (i.e. it will not be pulled tight on the locking bar) so that the QCD knot may be more easily untied, when tension of the pulling force is released and as illustrated in FIGS. 5A to 5D.

In some implementations, tying a knot according to the above method may take three to six seconds.

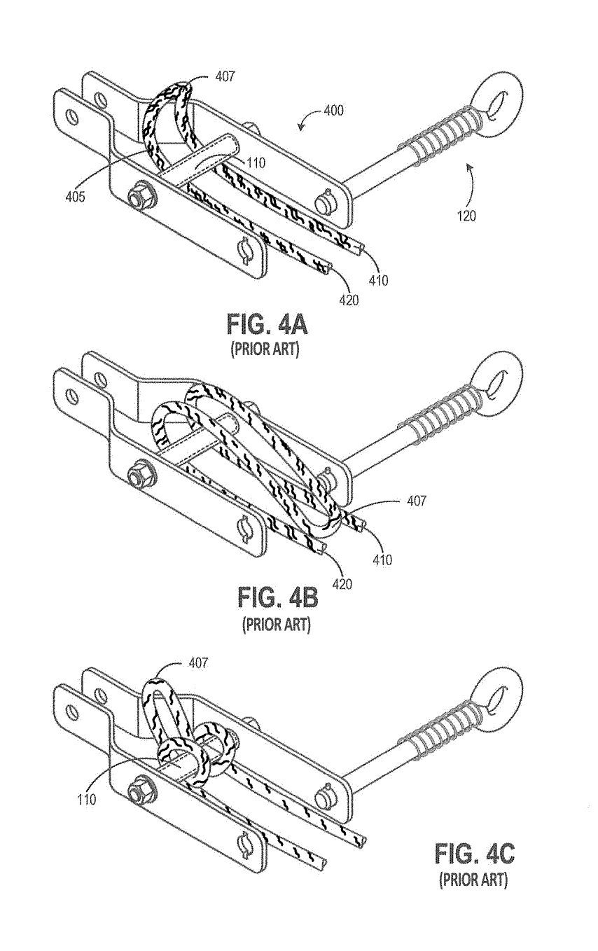

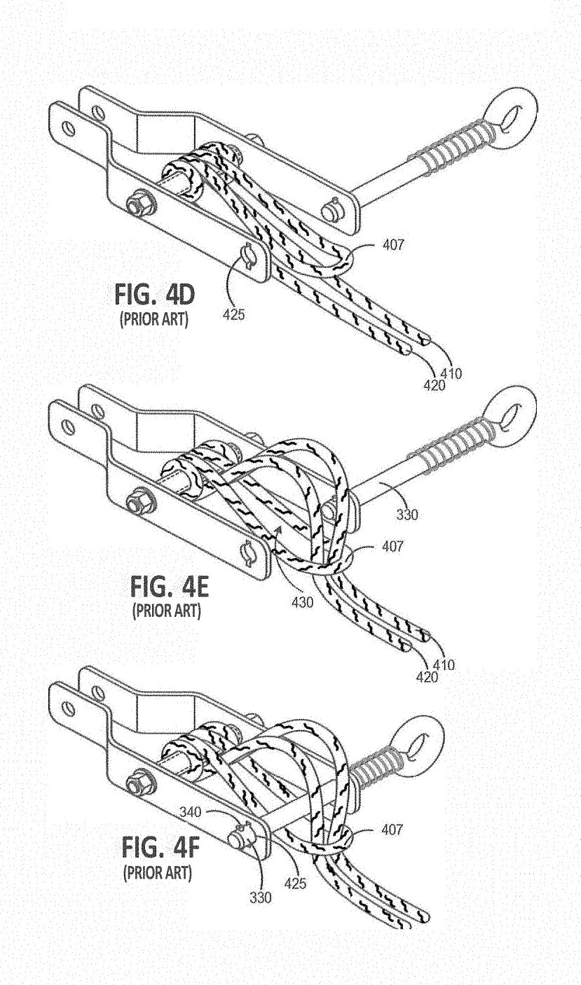

As stated in paragraph 0018 above, “The primary difference between the QCD and the SP-QCD is that with the QCD, the locking bar is inserted into the loops of rope to form the knot while the loops of rope are placed around a fixed locking bar in the case of the SP-QCD.” FIGS. 4A to 4F from patent U.S. Pat. No. 8,608,211 are reproduced next in the illustrations for this present disclosure to illustrate this more clearly.

As illustrated in FIGS. 5A to 5D, the first step in untying the QCD knot 350, as shown in FIG. 3F and after releasing the tension on the load leg 307c, which in turn may reduce the tension on locking portion 307h of the rope, is to slide the loose end leg 307c over the end 325 of locking bar 320 to produce the configuration illustrated in FIG. 5A.

Next, slide the rope legs 307c and 3307b off and over locking bar end 325 and below locking bar 320 as illustrated in FIG. 5B.

Then, slide the load leg 307c along the locking bar 320 to bring it up and over end 325 of the locking bar. This produces the configuration illustrated in FIG. 5C in which rope 307 is only looped around the load bar. By holding and pulling on legs 307b and 307c together, rope 307 may simply unwind from around the load bar 310 as is illustrated in FIG. 5D.

In some implementations, untying a knot according to the above method may take two to four seconds and may be considerable faster than the initial untying operation as disclosed in U.S. Pat. No. 8,608,211.

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

what is claimed is:

1. A single piece, quick connect and disconnect (SP-QCD) chassis for connecting and disconnecting a load via a connection medium to and from a pulling force, the SP-QCD chassis comprising:
a first rail;
a second rail;
a load bar integrally formed with the chassis between the first rail and the second rail to couple the first rail and the second rail;
a third rail integrally formed with the chassis and coupled to the first rail; and
a locking bar integrally formed with the chassis and coupled by the third rail to the load bar;
wherein the first rail, the second rail, the load bar, the third rail, and the locking bar are integrally formed and collectively form the single piece, quick connect and disconnect chassis.

2. The SP-QCD chassis of claim 1, further comprising:
a first connection medium to couple the SP-QCD chassis at a first end through the load bar and the locking bar to a load.

3. The SP-QCD chassis of claim 1, further comprising:
a second connection medium to couple the SP-QCD chassis at a second end to a pulling force.

4. QCD chassis of claim 2, wherein the first connection medium comprises a first connection medium selected from the group consisting of but not limited to: a rope, a strap, and any other rope like medium with required minimum breaking strength and flexibility.

5. The SP-QCD chassis of claim 3, wherein the second connection medium comprises a second connection medium selected from the group consisting of but not limited to: a grabbing hook, a ball knob, a tow bar/“U”-tongue hitching system with the “U” tongue on the SP-QCD chassis, a hook, an adapter, an integral bar, and an integral plate.

6. The SP-QCD chassis of claim 1, further comprising:
at least one protrusion disposed on the load bar and integrally formed with the chassis to facilitate improved coupling with a connection medium.

7. The SP-QCD chassis of claim 1, further comprising:
at least one protrusion disposed on the locking bar and integrally formed with the chassis to facilitate improved coupling with a connection medium.

8. A method for using a single piece, quick connect and disconnect (SP-QCD) chassis, the method comprising:
utilizing a single piece, quick connect and disconnect (SP-QCD) chassis for connecting and disconnecting a load via a connection medium to and from a pulling force, the SP-QCD chassis comprising: a first rail; a second rail; a load bar integrally formed with the chassis between the first rail and the second rail to couple the first rail and the second rail; a third rail integrally formed with the chassis and coupled to the first rail; and a locking bar integrally formed with the chassis and coupled by the third rail to the load bar; wherein the first rail, the second rail, the load bar, the third rail, and the locking bar are integrally formed and collectively form the single piece, quick connect and disconnect chassis;
folding a connection medium at any point along the connection medium to create a loop, a first leg and a second leg; then
bringing the loop under, up, and over the load bar; then
inserting the loop down between the load bar and locking bar; then
inserting the connection medium loop further down between the first leg and second leg; then
bringing the loop again under, up, and over the load bar and simultaneously spreading the loop to create a first compression point between the first leg section next to the load bar and a first leg section on top of the first leg section underneath it and to create a second compression point between the second leg section next to the load bar and a second leg section on top of the second leg section underneath it; then
bringing the first leg of the connection medium loop down and under the free end of the locking bar; then
pulling the first leg back under the locking bar to where the third rail is connected to the locking bar; then
bringing the other ends of the first leg and second leg of the loop up, around and over the locking bar; then
bringing the second leg of loop, located at the third rail, up and over the other ends of the first leg and second leg of the loop; and then
bringing over and under the end of the locking bar.

9. The method of claim 8, wherein the first leg or load leg is attached to or loops around a load to either hold it in place or pull it along as the SP-QCD is held in place or pulled by the pulling force.

10. The method of claim 8, wherein the first and second rail are connected to the pulling force by an integrated mechanism with the SP-QCD consisting of but not limited to either a patterned opening for a conventional grabbing hook and the grabbing hook that is in turn connected mechanically to the pulling force, or a circular/slot patterned opening for a conventional ball knob and the ball knob of a conventional ball and socket hitching system that is in turn connected mechanically to the pulling force, or the conventional “U” tongue of a conventional tow-bar/u-tongue hitching system that is in turn connected mechanically to the tow bar of the pulling force, or any adapter or integral plate or bar in which the SP-QCD chassis pattern is implemented that in turn is fastened by any means to a pulling force such as a tractor with a three point hitch or to a stationary point such as a rail or post on a dock, or a round hole on the pulling end of the SP-QCD chassis for bolting the chassis to either the frame or the shaft of a floating hitch connector on a pulling device, or for hooking a hook such as the hook on a bungee cord that the other end of the bungee cord is in turn connected to a rail or cleat of a conventional pickup or flatbed truck wherein the elasticity of the bungee cord provides the pulling force.

11. The method of claim 8, wherein the second leg is the loose end of the rope and stowed on the pulling implement or continues and connects to a second load.

12. The method of claim 8, further comprising:
untying the knot by reducing the tension on the first or load leg and/or the second leg or loose end leg that may or may not be connected to an additional load so that the second leg may be moved from under and then up and over the end of the locking bar; then
sliding the first and second legs of the other end of the rope loop off and below locking bar; then
sliding the first or load leg along underneath the locking bar to bring it up and over end of the locking bar; and then pulling on both the first and second leg at the end of the loop so that the loop unwinds from around the load bar so that the SP-QCD may be completely free from the rope and the pulling force on the rope is disconnected.

13. A quick connect and disconnect assembly for connecting and disconnecting a load via a connection medium to and from a pulling force, the assembly comprising:
a single piece, quick connect and disconnect (SP-QCD) chassis comprising:
a first rail;
a second rail;
a load bar integrally formed with the chassis between the first rail and the second rail to couple the first rail and the second rail;
a third rail integrally formed with the chassis and coupled to the first rail;
and
a locking bar integrally formed with the chassis and coupled by the third rail to the load bar;
wherein the first rail, the second rail, the load bar, the third rail, and the locking bar are integrally formed and collectively form the single piece, quick connect and disconnect chassis; and
a first connection medium to couple the SP-QCD chassis at a first end through the load bar and the locking bar to a load.

14. The quick connect and disconnect assembly of claim 13, further comprising:
a second connection medium to couple the SP-QCD chassis at a second end to a pulling force.

15. The quick connect and disconnect assembly of claim 13, wherein the first connection medium comprises a first connection medium selected from the group consisting of: a rope, a strap, and any other rope like medium with required minimum breaking strength and flexibility

16. The quick connect and disconnect assembly of claim 14, wherein the second connection medium comprises a second connection medium selected from the group consisting of: a grabbing hook, a ball knob, a tow bar of a conventional tow-bar/u-tongue hitching system, a hole, an adapter, an integral bar, and an integral plate.

17. The quick connect and disconnect assembly of claim 13, further comprising:
at least one protrusion disposed on the load bar and integrally formed with the chassis to facilitate improved coupling with a connection medium.

18. The quick connect and disconnect assembly of claim 13, further comprising:
at least one protrusion disposed on the locking bar and integrally formed with the chassis to facilitate improved coupling with a connection medium.

19. The pulling force of claim 14, wherein the pulling force is selected from a group comprising of but not limited to: a motor driven vehicle, a lever load binder, a ratchet load binder, a wench, a come-a-long, and a bungee cord.
